(19) United States
(12) Patent Application Publication
(10) Pub. No.: US 2026/0359719 A1
(43) Pub. Date: Nov. 12, 2026

(54) HIRE AI: Trait-Based Ethical Scoring and Fallback System for Language Models

(71) Applicant: Asmaa Hammouch, Kristiansand (NO)

(72) Inventor: Asmaa Hammouch, Kristiansand (NO)

(21) Appl. No.: 19/245,502

(22) Filed: Jun. 23, 2025

Related U.S. Application Data
(60) Provisional application No. 63/802,671, filed on May 9, 2025.

(51) Int. Cl. G06N 20/00

(52) U.S. Cl. CPC G06N 20/00

(57) ABSTRACT

A scoring engine evaluates outputs from language models to determine ethical alignment based on the traits of Humility, Integrity, Respect, and Empathy. The system includes a calibration module that adjusts model behavior using user feedback and audit logs. When ethical misalignment is detected, a fallback protocol is triggered to replace or correct responses. This invention improves artificial intelligence safety and accountability by providing a trait-based reinforcement mechanism for ethical natural language generation.

This specification relates to systems and methods for Human Integrity Recognition and Encoding (HIRE) using machine learning and artificial intelligence.

The HIRE AI framework evaluates and encodes behavioral signals along four primary traits: Humility, Integrity, Respect, and Empathy.

The system operates by extracting interaction data and mapping it into a decision-quality matrix informed by HIRE-aligned reinforcement scoring.

In one embodiment, the system includes a trait-flagging module that assigns probability scores to each of the four HIRE traits in near real time.

An interface layer provides feedback to users, organizations, or downstream AI systems based on HIRE alignment levels.

1. A computer-implemented system for generating and filtering natural language output based on emotional and ethical scoring, comprising:
a) a dual empathy scoring module configured to calculate an input empathy score (Score A) from a user's message and an output empathy score (Score B) from a candidate AI-generated response;
b) a trait evaluation module comprising classifiers or logic rules for detecting violations of predefined ethical traits, including but not limited to humility, integrity, respect, and empathy;
c) a response filtering engine that automatically evaluates the AI-generated response based on said scores and ethical traits and selectively allows, modifies, or rejects the response;
d) a fallback response module that substitutes a pre-approved response when the output fails to meet one or more empathy or ethical thresholds;
e) a logging mechanism for recording violations to inform adaptive learning, retraining, or reinforcement feedback processes.

2. The system of claim 1, wherein the empathy scoring module employs both sentiment classification and emotion detection using rule-based or machine learning techniques.

3. The system of claim 1, wherein the trait evaluation module includes a neural or symbolic classifier for each trait selected from: humility, integrity, respect, empathy, and optionally other configurable values.

4. The system of claim 1, wherein the fallback response module selects a templated message aligned with the violated trait.

5. The system of claim 1, wherein the output empathy score is compared against a configurable threshold to determine response eligibility.

6. The system of claim 1, wherein the system triggers retraining of the language generation model based on aggregated log data of trait violations.

7. The system of claim 1, wherein the system further comprises a multidimensional response orchestration layer that balances informational, emotional, and ethical needs in real-time.
